(19) United States
(12) Patent Application Publication
(10) Pub. No.: US 2011/0091745 A1
(43) Pub. Date: Apr. 21, 2011

(54) APPARATUS FOR ENERGY STORAGE OF MICROBIAL FUEL CELL AND MICROBIAL FUEL CELL ENERGY STORAGE SYSTEM COMPRISING SAID APPARATUS

(75) Inventors: JUNG-CHIEH SU, Taipei (TW); JUNG-JENG SU, Taipei (TW)

(73) Assignee: National Taiwan University of Science and Technology, Taipei (TW)

(21) Appl. No.: 12/749,869

(22) Filed: Mar. 30, 2010

(30) Foreign Application Priority Data
Oct. 15, 2009 (TW) 098134904

(51) Int. Cl. H01M 8/16

(52) U.S. Cl. 429/2

(57) ABSTRACT

The present invention relates to an electric energy storage apparatus having a configuration comprising at least a capacitor and an inductor, wherein the electric energy storage apparatus provides storage of charges generated from microbial fuel cells, and the inductor of the electric energy storage apparatus is capable of converting part of the alternative current power generated by the microbial fuel cell into a direct current power. This direct portion of electric power is a part of the electric power supplied to the energy storage apparatus. The storage of the energy storage apparatus also can be stabilized by the electromagnetically induced feedback mechanism. Therefore, the stabilization of energy storage of the microbial fuel cell can be achieved simultaneously. The present invention also provides a microbial fuel cell energy storage system comprising a microbial fuel cell and the apparatus.

### FIELD OF THE INVENTION

The present invention relates to an electric energy storage apparatus, for example the electric energy storage apparatus for microbial fuel cells, hydrogen fuel cells, methane fuel cells, etc., and more particularly, the present invention relates to an electric energy storage apparatus for microbial fuel cells, wherein the apparatus comprises at least a capacitor and an inductor. The present invention relates to a microbial fuel cell energy storage system comprising a microbial fuel cell and the apparatus.

### BACKGROUND OF THE INVENTION

Because of the energy shortage and the climatic problems caused by global warming, the development of renewable energy has been becoming increasingly important research item for the reduction of environmental pollution and sustainable development, and one of the key items of energy development is bioenergy, in particular biomass energy and microbial fuel cells that utilize biomass as plants convert the solar energy into chemical energy through photosynthesis and store the chemical energy in the biomass of the plants. Biomass energy originates from the biomass which can be converted by enzymes or various biochemical technologies into biodiesel, bioethanol, or various types of biofuel. Microbial fuel cells make use of microorganisms to cause fermentation, anaerobic reactions, or facultatively anaerobic reactions to generate electric power. Thus, microbial fuel cells can generate electric power while the microorganisms inside them decompose organic pollution.

It has already proven for a long time that conventional microbial fuel cells can generate electric power from biomass, but their conversion efficiency is very low as microorganisms can decompose only a portion of organic matter so that only a small amount of electrons can be carried to cathode. Therefore, some microbial fuel cells need to be added with dissolvable poisonous electronic mediators which help electrons be transported from the microorganisms to anode, but that is harmful to the environment. The recent study of microbial fuel cells has increased the conversion efficiency by utilizing nonpoisonous electronic mediators, improving the materials of the electrode and the proton exchange membrane, selecting species of bacteria, and improving the structure of cells, and microbial fuel cells have been utilized in the field of the disposal of waste water and mud on the seabed.

Because biological sludge contains special microorganisms with electron affinity, it has already proven that they can transport electrons without adding any electronic mediators. However, when microbial fuel cells utilize the aforesaid sewage or sludge as organic fuel, the current generated by each microbial fuel cell will be too small as most of the organic matter will not generate electronic power because the sewage or anaerobic sludge contains complicated species of bacteria. As bacteria do not directly transport electrons generated by the glycolysis to Anode but to the electron acceptors at the end of the electron transport chain, it is an important key to the technology of transforming biological energy into electricity by transporting the electrons to anode. Thus, from the above description, it is noted that there is in need of an electric energy storage apparatus designed for a microbial fuel cell which can store electric charges generated by the microbial fuel cell according to the electricity generation performance of various bacterium species so that the electric energy storage of the apparatus can be stabilized for a long time.

### SUMMARY OF THE INVENTION

The present invention provides an apparatus which can transform a portion of the alternating electric power generated by a microbial fuel cell into electric energy to be stored by utilizing the electromagnetic induction so as to improve the electric energy storage efficiency of the microbial fuel cell. In particular, the present invention utilizes at least an inductor and a capacitor which stores the electric energy generated by a microbial fuel cell to form a circuit configuration. When the inductor of the circuit configuration interacts with the microbial fuel cell and induces a current which causes the electric charge transport modulation inside the microbial fuel cell by the electromagnetically induced feedback mechanism, the stable storage of the microbial fuel cell can be achieved.

The present invention relates to an electric energy storage apparatus comprising an inductor in series connection or parallel connection with a capacitor. The performance and efficiency of the electric energy storage of a microbial fuel cell depend on its materials and structure design and the manufacturing process of its components and so on, and the stability of electric energy storage depends on the efficiency of storage and generation of electric energy. Hence, it is the main method of stabilizing the storage of electric energy for an electric energy storage apparatus designed for microbial fuel cells with specific materials and specific structure to modulate the storage and generation of electrons. Hereinafter, the present invention provides an electric energy storage apparatus comprising an inductor in series connection with a capacitor designed for microbial fuel cells as an example of interpretation.

The present invention converts a portion of the alternative current power generated by a microbial fuel cell into a direct current electric power by utilizing electromagnetic induction, and then the direct current electric power will be stored in a capacitor so as to achieve the merit of energy regeneration. Moreover, the present invention utilizes active control over an electric energy storage apparatus so that the storage of electric charges can be modulated at any time for the purpose of improving the storage efficiency of electric energy. In particular, the present invention utilizes an inductor utilizing the effect of electromagnetic induction to provide an improved apparatus for the electric energy storage of a microbial fuel cell. When compared with the present invention, the conventional storage method of a microbial fuel cell passively stores electric energy in a capacitor or battery so that the storage of electric charges can not be modulated adapting to the bacterial reaction in the microbial fuel cell for the purpose of stabilizing the current storage. The conventional storage method can not make use of the alternating electric power to generate energy. The present invention can convert a portion of the alternative current power generated by the microbial fuel cell into a direct current electric power by utilizing electromagnetic induction. The capacitor can store the direct electric power, and at the same time, the inductor can make use of a certain proportion of the alternative current power to retrieve electric charges so as to improve the efficiency of the storage apparatus. And the improvement of the efficiency leads to both an increase in the accumulation rate of electric charges to be stored in the capacitor and a reduction in the loss of electric energy caused by alternating current which can not be stored. When the forward current reduces, the inductor will generate a reverse voltage due to electromagnetic induction, which results in a forward current being capable of compensating the reduction in the accumulation amount of electric charges due to the reduction in the forward current.

For example, when a microbial fuel cell generates too much forward current, the inductor will provide a feedback of reverse voltage into the microbial fuel cell, and then a induced current will be generated and interact electrically with the bacteria inside the microbial fuel cell to reduce the generation of electric energy.

It has been proven as shown in FIG. 1 that microbial fuel cells, as mentioned above, can generate both alternating current and direct current. FIG. 1 shows the variation of the voltages across an inductor after the inductor has been connected to a microbial fuel cell. In FIG. 1, when the microbial fuel cell is connected with a 200 mH inductor in series, a nearly stable voltage across the inductor was observed. Therefore, the output current of the microbial fuel cell is composed of alternating current, and generates the voltages across the inductor. According to the electromagnetic principle, alternating current can not be stored in any capacitor. However, the inductor can provide the microbial fuel cell with a feedback of reverse voltage due to electromagnetic induction, and then the microbial fuel cell will charge the capacitor via direct current. Therefore, the loss of the electric energy storage due to the alternating current will be compensated through the complementary effect introduced by the combination of the inductor and the capacitor. Through the interaction among the microbial fuel cell, capacitor, and inductor, a configuration of a feedback circuit can be formed in the energy storage apparatus, and at the same time, the storage of the energy storage apparatus can also be stabilized by the electromagnetically induced feedback mechanism.

The present invention also relates to a microbial fuel cell energy storage system comprising a microbial fuel cell and the aforesaid apparatus.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 shows the variation of the voltage across a 200 mH inductor connected in series with a microbial fuel cell.

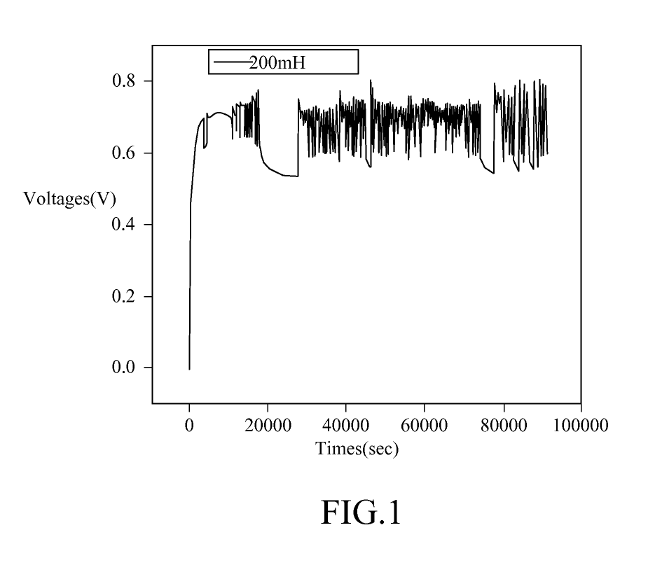

FIG. 2 shows a schematic view of the circuit of an energy storage apparatus according to an embodiment of the present invention when connected with a microbial fuel cell to form a microbial fuel cell energy storage system.

FIG. 3 shows a schematic view of the circuit of an energy storage apparatus according to another embodiment of the present invention when connected with a microbial fuel cell to form a microbial fuel cell energy storage system.

### DESCRIPTION OF THE EXEMPLARY EMBODIMENTS

For the esteemed members of reviewing committee to further understand and recognize the fulfilled functions and structural characteristics of the invention, the exemplary embodiment cooperating with detailed description are presented as follows.

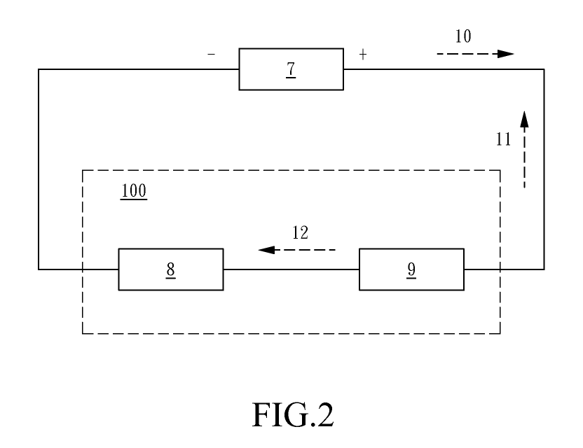

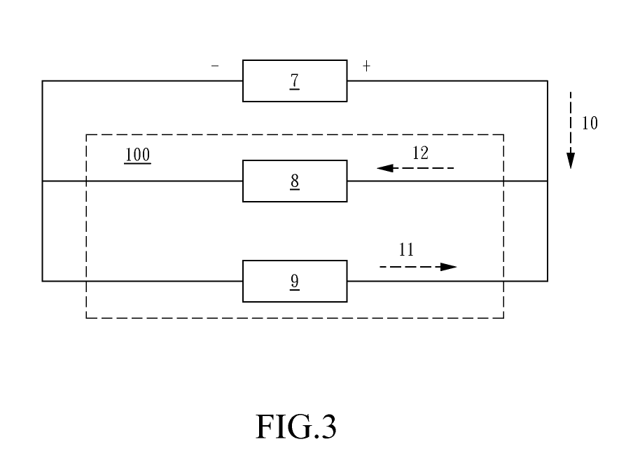

Please refer FIG. 2 and FIG. 3, which show schematic views of the circuit of an energy storage apparatus according to two embodiments of the present invention when connected with a microbial fuel cell 7 to form a microbial fuel cell energy storage system. The energy storage apparatus 100 comprises:
at least one inductor 9, being connected in series with a capacitor 8; and
a capacitor 8, being capable of storing electric energy.

Furthermore, the microbial fuel cell energy storage system comprises:
a microbial fuel cell 7; and
an energy storage apparatus 100, which further comprises:
   at least one inductor 9, being connected in parallel with a capacitor 8; and
   a capacitor 8, being capable of storing electric energy.

The inductor 9 has the function of transforming alternating power into a portion of electric power to be stored in the energy storage apparatus 100. At the same time, the energy storage of the energy storage apparatus 100 can be stabilized by the electromagnetic induced feedback effect generated by the inductor 9. Therefore, the inductor 9 transforms a portion of the alternating power as an auxiliary source of energy storage, and the energy storage apparatus 100 has the function of stabilizing the storage of energy.

Please refer to FIG. 2, which shows a schematic view of the circuit of an energy storage apparatus according to an embodiment of the present invention when connected with a microbial fuel cell to form a microbial fuel cell energy storage system. The solid lines represent the connections between the components, and the dotted lines 10, 11, and 12 represent currents and their direction. The energy storage apparatus 100 is electrically connected with a microbial fuel cell 7, wherein the capacitor 8 and the inductor 9 in the energy storage apparatus 100 are electrically connected in series. The inductor 9 can generate induced electromotive force when the input current varies with time. The capacitor 8 can store electric charges generated by the microbial fuel cell 7. The total amount of electric energy stored in the capacitor 8 of the energy storage apparatus 100 can be divided into two parts; one is provided by the current 10 generated by the microbial fuel cell 7 and the other is provided by the charging current 12 generated through the interaction between the microbial fuel cell 7 and the induced current 11 generated by the inductor 9. As the direction shown in FIG. 2, the microbial fuel cell 7 generates the current 10, wherein the alternating portion of the current 10 enters the inductor 9 and the direct portion of the current 10 enters the capacitor 8 generating a voltage across the capacitor 8. When the alternating current is applied to the inductor 9, the inductor 9 will generate the electromagnetically induced current 11, and then the electromagnetically induced current 11 will be transformed into the charging current 12 that is a direct current and enters the capacitor 8.

Please refer to FIG. 3, which shows a schematic view of the circuit of an energy storage apparatus 100 according to an embodiment of the present invention when connected with a microbial fuel cell 7 to form a microbial fuel cell energy storage system. The solid lines represent the connections between the components, and the dotted lines 10, 11, and 12 represent currents and their direction. The energy storage apparatus 100 is electrically connected with a microbial fuel cell 7, wherein the capacitor 8 and the inductor 9 in the energy storage apparatus 100 are electrically connected in parallel. As the direction shown in FIG. 3, the microbial fuel cell 7 generates the current 10, wherein the alternating portion of the current 10 enters the inductor 9 and the direct portion of the current 10 enters the capacitor 8 generating a voltage across the capacitor 8. When the alternating current is applied to the inductor 9, the inductor 9 will generate the electromagnetically induced current 11, and then the electromagnetically induced current 11 will be transformed into the charging current 12 that is a direct current and enters the capacitor 8.

Although the present invention described here is provided for microbial fuel cells, it should be realized that the application of the present invention is not limited to microbial fuel cells. The energy storage apparatus of the present invention can also be utilized as an energy storage apparatus of fuel cells of other kinds.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. An energy storage apparatus for a microbial fuel cell, comprising:
at least one inductor, being capable of generating currents by electromagnetic induction; and
a capacitor, being capable of storing electric energy.

2. The energy storage apparatus for a microbial fuel cell of claim 1, wherein the at least one inductor and the capacitor in the energy storage apparatus are electrically connected in series.

3. The energy storage apparatus for a microbial fuel cell of claim 1, wherein the at least one inductor and the capacitor in the energy storage apparatus are electrically connected in parallel.

4. A microbial fuel cell energy storage system, comprising:
a microbial fuel cell; and
an energy storage apparatus, which further comprises:
at least one inductor, being capable of generating currents by electromagnetic induction; and
a capacitor, being capable of storing electric energy.

5. The energy storage apparatus for a microbial fuel cell of claim 4, wherein the at least one inductor and the capacitor in the energy storage apparatus are electrically connected in series.

6. The energy storage apparatus for a microbial fuel cell of claim 4, wherein the at least one inductor and the capacitor in the energy storage apparatus are electrically connected in parallel.
